(19) United States
(12) Patent Application Publication
(10) Pub. No.: US 2024/0141154 A1
(43) Pub. Date: May 2, 2024

(54) CROSSLINKED RUBBER COMPOSITION AND FRICTION TRANSMISSION BELT OBTAINED USING SAME

(71) Applicant: BANDO CHEMICAL INDUSTRIES, LTD., Kobe-shi (JP)

(72) Inventors: Noriaki NAODA, Kobe-shi (JP); Masaki KIMURA, Kobe-shi (JP); Takayuki OKUBO, Kobe-shi (JP)

(73) Assignee: BANDO CHEMICAL INDUSTRIES, LTD., Kobe-shi (JP)

(21) Appl. No.: 18/406,181

(22) Filed: Jan. 7, 2024

Related U.S. Application Data
(63) Continuation of application No. PCT/JP2022/025675, filed on Jun. 28, 2022.

(30) Foreign Application Priority Data
Jul. 7, 2021 (JP) 2021-112745

(51) Int. Cl. C08L 23/16; F16G 5/06; F16G 5/20

(52) U.S. Cl. CPC C08L 23/16; F16G 5/06; F16G 5/20; C08L 2205/025; C08L 2205/035; C08L 2205/16; C08L 2312/02

(57) ABSTRACT

A crosslinked rubber composition includes: a rubber component containing a first polymer which is an ethylene-α-olefin elastomer having an ethylene content of less than 60% by mass and a second polymer which is an ethylene-α-olefin elastomer having an ethylene content of 60% by mass or more; and short fibers dispersed in the rubber component. The rubber component is crosslinked by using organic peroxide as a crosslinking agent. The content of the organic peroxide in a not-yet crosslinked rubber composition is 1 part by mass or more and 10 parts by mass or less relative to 100 parts by mass of the rubber component.

### CROSS-REFERENCE TO RELATED APPLICATIONS

This is a continuation of International Application No. PCT/JP2022/025675 filed on Jun. 28, 2022, which claims priority to Japanese Patent Application No. 2021-112745 filed on Jul. 7, 2021. The entire disclosures of these applications are incorporated by reference herein.

### BACKGROUND

The present invention relates to a crosslinked rubber composition and a friction transmission belt using the crosslinked rubber composition.

A crosslinked rubber composition has been known, in which a rubber component contains a plurality of kinds of EPDMs having different ethylene contents. For example, Japanese Unexamined Patent Publication No. 2016-141750 discloses a crosslinked rubber composition for rubber boots which is crosslinked by using sulfur and in which a rubber component contains an EPDM having an ethylene content of 64% by mass and an EPDM having an ethylene content of 50% by mass. Japanese Patent No. 6082853 discloses a friction transmission belt in which a pulley contact portion is made of a rubber composition crosslinked by using sulfur, and in the rubber composition, a rubber component contains a first EPDM having an ethylene content of 67% by mass or more and a second EPDM having an ethylene content of 57% by mass or less.

### SUMMARY

The present invention is a crosslinked rubber composition including: a rubber component containing a first polymer which is an ethylene-α-olefin elastomer having an ethylene content of less than 60% by mass and a second polymer which is an ethylene-α-olefin elastomer having an ethylene content of 60% by mass or more; and short fibers dispersed in the rubber component, wherein the rubber component is crosslinked by using organic peroxide as a crosslinking agent, and a content of the organic peroxide in a not-yet crosslinked rubber composition is 1 part by mass or more and 10 parts by mass or less relative to 100 parts by mass of the rubber component.

The present invention is a friction transmission belt having a pulley contact surface made of the crosslinked rubber composition of the present invention.

### BRIEF DESCRIPTION OF THE DRAWINGS

FIG. 1A is a perspective view of a piece of single-cogged V-belt.

FIG. 1B is a perspective view of a piece of double-cogged V-belt.

### DETAILED DESCRIPTION

An embodiment will be described in detail below.

A crosslinked rubber composition according to the embodiment contains a rubber composition and short fibers dispersed in the rubber component. The rubber component contains a first polymer which is an ethylene-α-olefin elastomer having an ethylene content of less than 60% by mass and a second polymer which is an ethylene-α-olefin elastomer having an ethylene content of 60% by mass or more. The rubber component is crosslinked by using organic peroxide as a crosslinking agent, and the content of the organic peroxide in a not-yet crosslinked rubber composition is 1 part by mass or more and 10 parts by mass or less relative to 100 parts by mass of the rubber component.

The crosslinked rubber composition according to the embodiment is crosslinked by using the organic peroxide and contains the rubber component having the short fibers dispersed therein and containing the first polymer which is an ethylene-α-olefin elastomer having the ethylene content of less than 60% by mass and the second polymer which is an ethylene-α-olefin elastomer having the ethylene content of 60% by mass or more. This composition makes it possible to obtain superior wear resistance. This composition also makes it possible to obtain superior workability.

Examples of the first and second polymers include, for example, an ethylene-propylene-diene terpolymer (hereinafter referred to as “EPDM”), an ethylene-propylene copolymer (EPM), an ethylene-butene copolymer (EDM), and an ethylene-octene copolymer (EOM). Among these, EPDM is suitable as the first and second polymers. In the case of EPDM, examples of the diene component include, for example, ethylidene norbornene, dicyclopentadiene, and 1,4-hexadiene. Among these, ethylidene norbornene is suitable as the diene component. EPDM is suitable as both of the first and second polymers, and EPDM in which the diene component is ethylidene norbornene is more suitable.

The first and second polymers are a main part of the rubber component. The sum of the contents of the first and second polymers in the rubber component is 50% by mass or more, and is suitably 80% by mass or more, more suitably 90% by mass or more, and much more suitably 100% by mass in order to obtain superior wear resistance and workability. The rubber component may contain, for example, chloroprene rubber, hydrogenated nitrile rubber, etc., other than the first and second polymers.

Suitably, the content A of the first polymer in the rubber component is more than the content B of the second polymer in the rubber component in order to obtain superior wear resistance and workability. From a similar point of view, the content A of the first polymer in 100 parts by mass of the rubber component is suitably more than 50 parts by mass, more suitably 55 parts by mass or more, much more suitably 60 parts by mass or more, and still more suitably 61 parts by mass or more, and from a similar point of view, suitably 75 parts by mass or less, more suitably 70 parts by mass or less, and much more suitably 69 parts by mass or less.

The content B of the second polymer in 100 parts by mass of the rubber component is suitably 25 parts by mass or more, more suitably 30 parts by mass or more, and much more suitably 31 parts by mass or more in order to obtain superior wear resistance and workability, and from a similar point of view, suitably less than 50 parts by mass, more suitably 45 parts by mass or less, much more suitably 40 parts by mass or less, and still more suitably 39 parts by mass or less.

The ethylene content of the first polymer is less than 60% by mass, and is suitably 45% by mass or more, and more suitably 50% by mass or more in order to obtain superior wear resistance and workability, and suitably 55% by mass or less from a similar point of view.

The ethylene content of the second polymer is 60% by mass or more, and is suitably 65% by mass or more in order to obtain superior wear resistance and workability, and from a similar point of view, suitably 75% by mass or less and more suitably 70% by mass or less.

The average ethylene content of the first and second polymers in the rubber component is suitably 55% by mass or more, and more suitably 57.5% by mass or more in order to obtain superior wear resistance and workability, and from a similar point of view, suitably 65% by mass or less, more suitably 61% by mass or less, and much more suitably 58% by mass or less. Here, the average ethylene content of the first and second polymers in the rubber component is the sum of the product of the content of the first polymer in the rubber component and its ethylene content and the product of the content of the second polymer in the rubber component and its ethylene content.

If the first polymer is an EPDM in which the diene component is ethylidene norbornene, the ENB content is suitably 7% by mass or more, and more suitably 7.5% by mass or more in order to obtain superior wear resistance and workability, and from a similar point of view, suitably 8.5% by mass or less, and more suitably 8% by mass or less.

If the second polymer is an EPDM in which the diene component is ethylidene norbornene, the ENB content is suitably 2% by mass or more, and more suitably 4.3% by mass or more in order to obtain superior wear resistance and workability, and from a similar point of view, suitably 7% by mass or less, and more suitably 4.7% by mass or less.

If both of the first and second polymers are EPDMs in which the diene component is ethylidene norbornene, the average ENB content of the first and second polymers in the rubber component is suitably 4% by mass or more, and more suitably 6.5% by mass or more in order to obtain superior wear resistance and workability, and from a similar point of view, suitably 7% by mass or less, and more suitably 6.6% by mass or less. Here, the average ENB content of the first and second polymers in the rubber component is the sum of the product of the content of the first polymer in the rubber component and its ENB content and the product of the content of the second polymer in the rubber component and its ENB content.

Examples of the short fibers include, for example, polyester short fibers, nylon 66 short fibers, para-aramid short fibers, and polyethylene naphthalate short fibers. The short fibers suitably include one kind or two or more kinds of these short fibers, and in order to obtain superior wear resistance and workability, the short fibers more suitably include the polyester short fibers and/or the nylon 66 short fibers and much more suitably include both of the polyester short fibers and the nylon 66 short fibers. If the short fibers include both of the polyester short fibers and the nylon 66 short fibers, the content of the nylon 66 short fibers is suitably greater than the content of the polyester short fibers.

The short fibers have a fiber length ranging from 0.5 mm to 5.0 mm, for example. The short fibers have a fiber diameter ranging from 5 μm to 70 μm, for example. The content of the short fibers in the rubber composition according to the embodiment ranges from 5 parts by mass to 35 parts by mass, for example, relative to 100 parts by mass of the rubber component.

Examples of the organic peroxide for crosslinking the rubber component include, for example: dialkyl peroxides, such as dicumyl peroxide, 1,3-di(t-butylperoxy)diisopropylbenzene, 1,4-di(t-butylperoxy)diisopropylbenzene, t-butylcumyl peroxide, 2,5-dimethyl-2,5-di(t-butylperoxy)hexane, and 2,5-dimethyl-2,5-bis(t-butylperoxy)hexane-3; peroxyketal s, such as 1,1-di(t-hexylperoxy)cyclohexane, 1,1-di(t-butylperoxy)cyclohexane, and n-butyl-4,4-di(t-butylperoxy)valerate; and peroxyesters, such as 2,5-dimethyl-2,5-di(benzoylperoxy)hexane, t-hexylperoxybenzoate, and t-butylperoxybenzoate.

The organic peroxide suitably includes one kind or two or more kinds of these substances, and more suitably includes dialkyl peroxide, much more suitably includes dialkyl peroxide having an aromatic ring in a molecule, still much more suitably includes dialkyl peroxide having one aromatic ring in a molecule, still more suitably includes 1,3-di(t-butylperoxy)diisopropylbenzene, and yet more suitably includes both 1,3-di(t-butylperoxy)diisopropylbenzene and 1,4-di(t-butylperoxy)diisopropylbenzene, in order to obtain superior wear resistance and workability. The molecular weight of the organic peroxide is suitably 300 or more and 350 or less from a similar point of view.

The content C of the organic peroxide in the not-yet crosslinked rubber composition is 1 part by mass or more and 10 parts by mass or less relative to 100 parts by mass of the rubber component, and is suitably 1.1 parts by mass or more, more suitably 1.2 parts by mass or more, and much more suitably 1.6 parts by mass or more, and is suitably 3.6 parts by mass or less, more suitably 3.2 parts by mass or less, and much more suitably 2.8 parts by mass or less in order to obtain superior wear resistance and workability.

The ratio (A/C) of the content A of the first polymer to the content C of the organic peroxide in the not-yet crosslinked rubber composition is suitably 9.25 or more, more suitably or more, and much more suitably 11.25 or more, and is suitably 64 or less, more suitably 63.5 or less, and much more suitably 63 or less in order to obtain superior wear resistance and workability.

The ratio (B/C) of the content B of the second polymer to the content C of the organic peroxide in the not-yet crosslinked rubber composition is suitably 5.5 or more, more suitably 6.25 or more, and much more suitably 7.5 or more, and is suitably 46 or less, more suitably 45.5 or less, and much more suitably 45 or less in order to obtain superior wear resistance and workability.

Suitably, in the crosslinked rubber composition according to the embodiment, the rubber component is crosslinked by using a co-crosslinking agent, as well, in order to obtain superior wear resistance and workability. Examples of the co-crosslinking agent include, for example, trimethylol propane trimethacrylate, N,N′-m-phenylenebismaleimide, triallyl isocyanurate, ethylene glycol dimethacrylate, and liquid polybutadiene. The co-crosslinking agent suitably includes one kind or two or more kinds of these substances, and more suitably includes trimethylol propane trimethacrylate in order to obtain superior wear resistance and workability.

The content D of the co-crosslinking agent in the not-yet crosslinked rubber composition is suitably 0.5 parts by mass or more, more suitably 0.7 parts by mass or more, and much more suitably 1 part by mass or more, and is suitably 40 parts by mass or less, more suitably 20 parts by mass or less, and much more suitably 10 parts by mass or less relative to 100 parts by mass of the rubber component in order to obtain superior wear resistance and workability.

The ratio (A/D) of the content A of the first polymer to the content D of the co-crosslinking agent in the not-yet crosslinked rubber composition is suitably 0.8 or more, more suitably 1.0 or more, and much more suitably 1.5 or more, and is suitably 140 or less, more suitably 135 or less, and much more suitably 130 or less in order to obtain superior wear resistance and workability.

The ratio (B/D) of the content B of the second polymer to the content D of the co-crosslinking agent in not-yet crosslinked rubber composition is suitably 0.5 or more, more suitably 0.75 or more, and much more suitably 1 or more, and is suitably 100 or less, more suitably 95 or less, and much more suitably 90 or less in order to obtain superior wear resistance and workability.

The content D of the co-crosslinking agent in the not-yet crosslinked rubber composition is suitably less than the content C of the organic peroxide in the not-yet crosslinked rubber composition in order to obtain superior wear resistance and workability. From a similar point of view, the ratio (C/D) of the content C of the organic peroxide in the not-yet crosslinked rubber composition to the content D of the co-crosslinking agent in the not-yet crosslinked rubber composition is suitably 0.025 or more, more suitably 0.037 or more, and much more suitably 0.055 or more, and is suitably 20 or less, more suitably 7.2 or less, and much more suitably 6.4 or less.

The crosslinked rubber composition according to the embodiment may further contain carbon black, a vulcanization accelerator, a vulcanization accelerator aid, a processing aid, an antioxidant, etc.

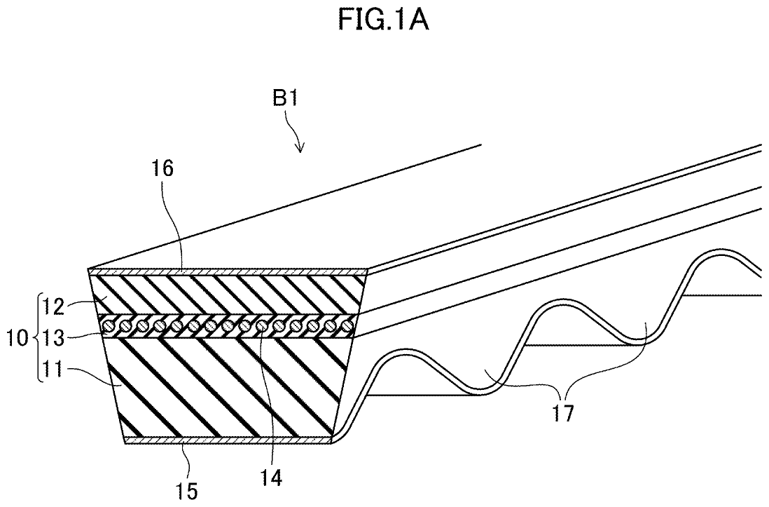

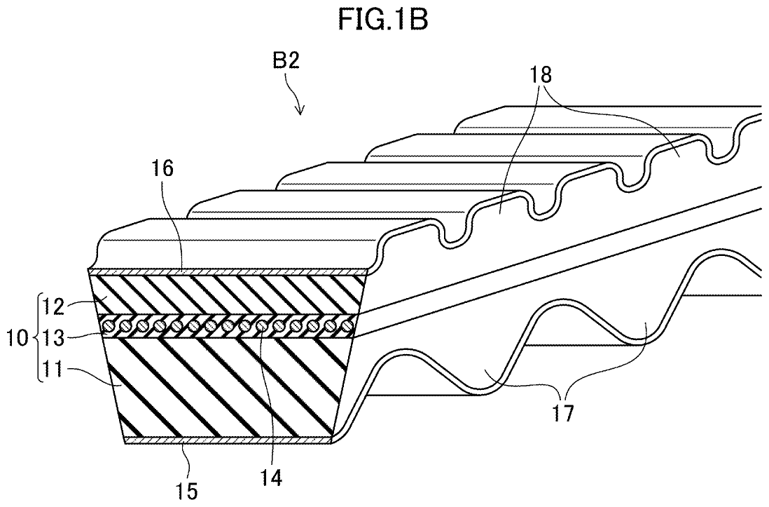

FIG. 1A is a single-cogged V-belt B1 which is one example of the friction transmission belt using the crosslinked rubber composition according to the embodiment. The single-cogged V-belt B1 is used, for example, as a transmission belt for a small scooter and an agricultural machine.

The single-cogged V-belt B1 has a belt body 10 made of rubber, having a trapezoidal cross-sectional shape, and including a compressed rubber layer 11 forming an inner peripheral side of the belt, a stretch rubber layer 12 forming an outer peripheral side of the belt, and an adhesive rubber layer 13 interposed therebetween, which are stacked on each other to form an integrally formed belt body 10. A cord 14 is embedded in a middle portion, in a belt thickness direction, of the adhesive rubber layer 13, such that the cord 14 forms a helical pattern having a pitch in a belt width direction. An inner reinforcing fabric 15 is bonded to a surface of the compressed rubber layer 11 which serves as an inner peripheral surface of the belt, and an outer reinforcing fabric 16 is bonded to a surface of the stretch rubber layer 12 which serves as an outer peripheral surface of the belt. The inner peripheral side of the belt has inner cogs 17 formed at a constant pitch in a belt length direction, whereas the outer peripheral side of the belt has a flat backface of the belt.

FIG. 1B is a double-cogged V-belt B2 which is another example of the friction transmission belt using the crosslinked rubber composition according to the embodiment. The double-cogged V-belt B2 is used, for example, as a transmission belt for a large buggy and a large scooter.

Similarly to the single-cogged V-belt B1, the double-cogged V-belt B2 has: a belt body including a compressed rubber layer 11, a stretch rubber layer 12, and an adhesive rubber layer 13; a cord 14 embedded in the adhesive rubber layer 13; and an inner reinforcing fabric bonded to an inner peripheral surface of the belt and an outer reinforcing fabric 16 bonded to an outer peripheral surface of the belt. The inner and outer peripheral sides of the belt have inner cogs 17 and outer cogs 18, respectively, at a constant pitch in the belt length direction.

In the single-cogged V-belt B1 and the double-cogged V-belt B2, the compressed rubber layer 11, which serves as pulley contact surfaces on both lateral sides of the belt body 10, is made of the crosslinked rubber composition according to the embodiment. Suitably, the crosslinked rubber composition according to the embodiment is provided so that the grain direction corresponds to the belt width direction.

The compressed rubber layer 11 of the single-cogged V-belt B1 and the double-cogged V-belt B2 for use for transmission is pressed against a pulley. However, since the pulley contact surfaces on both lateral sides of the compressed rubber layer 11 are made of the crosslinked rubber composition according to the embodiment, it is possible to obtain superior wear resistance.

In the above-described embodiment, the single-cogged V-belt B1 and the double-cogged V-belt B2 are described as the friction transmission belt, but the friction transmission belt is not particularly limited thereto and may be a flat belt, a V-belt, or a V-ribbed belt, for example.

### EXAMPLES

(Crosslinked Rubber Composition)

Wear test samples of crosslinked rubber compositions of Examples 1-1 to 1-4 and Comparative Example 1-1 to 1-2, Examples 2-1 to 2-4 and Comparative Example 2-1 to 2-2, Examples 3-1 to 3-4 and Comparative Example 3-1 to 3-2, and Examples 4-1 to 4-4 and Comparative Example 4-1 to 4-2, which will be described below, were produced. The composition of each sample is also shown in Tables 1 to 4.

### Example 1-1

A blend rubber containing 50 parts by mass of a first EPDM (T7241 manufactured by JSR Corporation, ethylene content: 52% by mass, ENB content: 7.7% by mass) as a first polymer and 50 parts by mass of a second EPDM-(1) (EP133C manufactured by JSR Corporation, ethylene content: 69% by mass, ENB content: 4.5% by mass) as a second polymer was used as a rubber component. The following substances were mixed relative to 100 parts by mass of this rubber component: 15 parts by mass of polyester short fibers (fiber length: 3 mm, fiber diameter: 23 μm); 60 parts by mass of carbon black (HAF); 5 parts by mass of process oil; 5 parts by mass of zinc oxide; 0.25 parts by mass of stearic acid; 2.5 parts by mass of an antioxidant; 7 parts by mass (2.8 parts by mass) of organic peroxide (PEROXYMON F-40 manufactured by NOF CORPORATION, and 1,3-di(t-butylperoxy)diisopropylbenzene and 1,4-di(t-butylperoxy)diisopropylbenzene, molecular weight: 338.49, purity: 40%); and 1.5 parts by mass of a co-crosslinking agent (Hi-Cross M manufactured by Seiko Chemical Co., Ltd., trimethylol propane trimethacrylate). The obtained mixture was kneaded, thereby preparing an uncrosslinked rubber composition. Using this uncrosslinked rubber composition, a wear test sample of a crosslinked rubber composition was produced as Example 1-1. The wear test sample was formed into a rectangular parallelepiped block shape with its both end faces having a 5 mm square shape and its length being 10 mm. The longitudinal direction of the wear test sample corresponds to the grain direction, which is the orientation direction of the polyester short fibers.

### Example 1-2

A wear test sample having the same composition as that of Example 1-1, except that a blend rubber containing 60 parts by mass of the first EPDM and 40 parts by mass of the second EPDM-(1) was used as the rubber component, was produced as Example 1-2.

### Example 1-3

A wear test sample having the same composition as that of Example 1-1, except that a blend rubber containing 65 parts by mass of the first EPDM and 35 parts by mass of the second EPDM-(1) was used as the rubber component, was produced as Example 1-3.

### Example 1-4

A wear test sample having the same composition as that of Example 1-1, except that a blend rubber containing 70 parts by mass of the first EPDM and 30 parts by mass of the second EPDM-(1) was used as a rubber component, was produced as Example 1-4.

### Example 1-5

A wear test sample having the same composition as that of Example 1-2, except that the second EPDM-(1) was replaced by a second EPDM-(2) (KELTAN 5260 manufactured by ARLANXEO, ethylene content: 62% by mass, ENB content: 2.3% by mass) as the second polymer, was produced as Example 1-5.

### Example 1-6

A wear test sample having the same composition as that of Example 1-5, except that a blend rubber containing 32 parts by mass of the first EPDM and 68 parts by mass of the second EPDM-(2) was used as the rubber component, was produced as Example 1-6.

### Comparative Example 1-1

A wear test sample having the same composition as that of Example 1-1, except that only the first EPDM was used as the rubber component, was produced as Comparative Example 1-1.

### Comparative Example 1-2

A wear test sample having the same composition as that of Example 1-3, except that the organic peroxide as the crosslinking agent was replaced by sulfur and that a vulcanization accelerator was used, wherein the content was 1.6 parts by mass and 4 parts by mass, respectively, relative to 100 parts by mass of the rubber component, was produced as Comparative Example 1-2.

### Examples 2-1 to 2-6 and Comparative Examples 2-1 and 2-2

Wear test samples having the same compositions as those of Examples 1-1 to 1-6 and Comparative Examples 1-1 and 1-2, except that nylon 66 short fibers (fiber length: 3 mm, fiber diameter: 27.3 μm) were used as the short fibers, were produced as Examples 2-1 to 2-6 and Comparative Examples 2-1 and 2-2, respectively.

### Examples 3-1 to 3-6 and Comparative Examples 3-1 and 3-2

Wear test samples having the same compositions as those of Examples 1-1 to 1-6 and Comparative Examples 1-1 and 1-2, except that para-aramid short fibers (fiber length: 3 mm, fiber diameter: 12 μm) were used as the short fibers, were produced as Examples 3-1 to 3-6 and Comparative Examples 3-1 and 3-2, respectively.

### Examples 4-1 to 4-6 and Comparative Examples 4-1 and 4-2

Wear test samples having the same compositions as those of Examples 1-1 to 1-6 and Comparative Examples 1-1 and 1-2, except that polyester short fibers and nylon 66 short fibers were used as the short fibers and that the contents thereof were 12 parts by mass and 18 parts by mass, respectively, relative to 100 parts by mass of the rubber component, were produced as Examples 4-1 to 4-6 and Comparative Examples 4-1 and 4-2, respectively.

TABLE 1

| | Example | | | | | | Comparative Example | |
|---|---|---|---|---|---|---|---|---|
| | 1-1 | 1-2 | 1-3 | 1-4 | 1-5 | 1-6 | 1-1 | 1-2 |
| First EPDM A | 50 | 60 | 65 | 70 | 60 | 32 | 100 | 65 |
| Second EPDM-(1) B | 50 | 40 | 35 | 30 | | | | 35 |
| Second EPDM-(2) B | | | | | 40 | 68 | | |
| PET Short Fibers | 15 | 15 | 15 | 15 | 15 | 15 | 15 | 15 |
| Nylon 66 Short Fibers | | | | | | | | |
| Aramid Short Fibers | | | | | | | | |
| Carbon Black | 60 | 60 | 60 | 60 | 60 | 60 | 60 | 60 |
| Process Oil | 5 | 5 | 5 | 5 | 5 | 5 | 5 | 5 |
| Zinc Oxide | 5 | 5 | 5 | 5 | 5 | 5 | 5 | 5 |
| Stearic Acid | 0.25 | 0.25 | 0.25 | 0.25 | 0.25 | 0.25 | 0.25 | 0.25 |
| Antioxidant | 2.5 | 2.5 | 2.5 | 2.5 | 2.5 | 2.5 | 2.5 | 2.5 |
| Organic Peroxide C | 2.8 | 2.8 | 2.8 | 2.8 | 2.8 | 2.8 | 2.8 | |
| Co-crosslinking Agent D | 1.5 | 1.5 | 1.5 | 1.5 | 1.5 | 1.5 | 1.5 | 1.5 |
| Sulfur | | | | | | | | 1.6 |
| Vulcanization Accelerator | | | | | | | | 4 |
| Average Ethylene | 60.5 | 58.8 | 57.95 | 57.1 | 56 | 58.8 | 52 | 57.95 |
| Content % by mass | | | | | | | | |
| Average ENB | 6.1 | 6.42 | 6.58 | 6.74 | 5.54 | 4.03 | 7.7 | 6.58 |
| Content % by mass | | | | | | | | |
| A/C | 17.9 | 21.4 | 23.2 | 25 | 21.4 | 11.4 | 35.7 | |
| B/C | 17.9 | 14.3 | 12.5 | 10.7 | 14.3 | 24.3 | — | |
| A/D | 33.3 | 40 | 43.3 | 46.7 | 40.0 | 21.3 | 66.7 | 43.3 |
| B/D | 33.3 | 26.7 | 23.3 | 20 | 26.7 | 45.3 | — | 23.3 |
| C/D | 1.87 | 1.87 | 1.87 | 1.87 | 1.87 | 1.87 | 1.87 | |
| Wear Amount mg | 5.4 | 5.0 | 4.2 | 5.0 | 4.4 | 2.1 | 6.7 | 7.2 |

TABLE 2

| | Example | | | | | | Comparative Example | |
|---|---|---|---|---|---|---|---|---|
| | 2-1 | 2-2 | 2-3 | 2-4 | 2-5 | 2-6 | 2-1 | 2-2 |
| First EPDM A | 50 | 60 | 65 | 70 | 60 | 32 | 100 | 65 |
| Second EPDM-(1) B | 50 | 40 | 35 | 30 | | | | 35 |
| Second EPDM-(2) B | | | | | 40 | 68 | | |
| PET Short Fibers | | | | | | | | |
| Nylon 66 Short Fibers | 15 | 15 | 15 | 15 | 15 | 15 | 15 | 15 |
| Aramid Short Fibers | | | | | | | | |
| Carbon Black | 60 | 60 | 60 | 60 | 60 | 60 | 60 | 60 |
| Process Oil | 5 | 5 | 5 | 5 | 5 | 5 | 5 | 5 |
| Zinc Oxide | 5 | 5 | 5 | 5 | 5 | 5 | 5 | 5 |
| Stearic Acid | 0.25 | 0.25 | 0.25 | 0.25 | 0.25 | 0.25 | 0.25 | 0.25 |
| Antioxidant | 2.5 | 2.5 | 2.5 | 2.5 | 2.5 | 2.5 | 2.5 | 2.5 |
| Organic Peroxide C | 2.8 | 2.8 | 2.8 | 2.8 | 2.8 | 2.8 | 2.8 | |
| Co-crosslinking Agent D | 1.5 | 1.5 | 1.5 | 1.5 | 1.5 | 1.5 | 1.5 | 1.5 |
| Sulfur | | | | | | | | 1.6 |
| Vulcanization Accelerator | | | | | | | | 4 |
| Average Ethylene | 60.5 | 58.8 | 57.95 | 57.1 | 56 | 58.8 | 52 | 57.95 |
| Content % by mass | | | | | | | | |
| Average ENB | 6.1 | 6.42 | 6.58 | 6.74 | 5.54 | 4.03 | 7.7 | 6.58 |
| Content % by mass | | | | | | | | |
| A/C | 17.9 | 21.4 | 23.2 | 25 | 21.4 | 11.4 | 35.7 | |
| B/C | 17.9 | 14.3 | 12.5 | 10.7 | 14.3 | 24.3 | — | |
| A/D | 33.3 | 40 | 43.3 | 46.7 | 40.0 | 21.3 | 66.7 | 43.3 |
| B/D | 33.3 | 26.7 | 23.3 | 20 | 26.7 | 45.3 | — | 23.3 |
| C/D | 1.87 | 1.87 | 1.87 | 1.87 | 1.87 | 1.87 | 1.87 | |
| Wear Amount mg | 4.9 | 4.4 | 3.6 | 4.8 | 3.2 | 2.3 | 6.1 | 6.3 |

TABLE 3

| | Example | | | | | | Comparative Example | |
|---|---|---|---|---|---|---|---|---|
| | 3-1 | 3-2 | 3-3 | 3-4 | 3-5 | 3-6 | 3-1 | 3-2 |
| First EPDM A | 50 | 60 | 65 | 70 | 60 | 32 | 100 | 65 |
| Second EPDM-(1) B | 50 | 40 | 35 | 30 | | | | 35 |
| Second EPDM-(2) B | | | | | 40 | 68 | | |
| PET Short Fibers | | | | | | | | |
| Nylon 66 Short Fibers | | | | | | | | |
| Aramid Short Fibers | 15 | 15 | 15 | 15 | 15 | 15 | 15 | 15 |
| Carbon Black | 60 | 60 | 60 | 60 | 60 | 60 | 60 | 60 |
| Process Oil | 5 | 5 | 5 | 5 | 5 | 5 | 5 | 5 |
| Zinc Oxide | 5 | 5 | 5 | 5 | 5 | 5 | 5 | 5 |
| Stearic Acid | 0.25 | 0.25 | 0.25 | 0.25 | 0.25 | 0.25 | 0.25 | 0.25 |
| Antioxidant | 2.5 | 2.5 | 2.5 | 2.5 | 2.5 | 2.5 | 2.5 | 2.5 |
| Organic Peroxide C | 2.8 | 2.8 | 2.8 | 2.8 | 2.8 | 2.8 | 2.8 | |
| Co-crosslinking Agent D | 1.5 | 1.5 | 1.5 | 1.5 | 1.5 | 1.5 | 1.5 | 1.5 |
| Sulfur | | | | | | | | 1.6 |
| Vulcanization Accelerator | | | | | | | | 4 |
| Average Ethylene | 60.5 | 58.8 | 57.95 | 57.1 | 56 | 58.8 | 52 | 57.95 |
| Content % by mass | | | | | | | | |
| Average ENB | 6.1 | 6.42 | 6.58 | 6.74 | 5.54 | 4.03 | 7.7 | 6.58 |
| Content % by mass | | | | | | | | |
| A/C | 17.9 | 21.4 | 23.2 | 25 | 21.4 | 11.4 | 35.7 | |
| B/C | 17.9 | 14.3 | 12.5 | 10.7 | 14.3 | 24.3 | — | |
| A/D | 33.3 | 40 | 43.3 | 46.7 | 40.0 | 21.3 | 66.7 | 43.3 |
| B/D | 33.3 | 26.7 | 23.3 | 20 | 26.7 | 45.3 | — | 23.3 |
| C/D | 1.87 | 1.87 | 1.87 | 1.87 | 1.87 | 1.87 | 1.87 | |
| Wear Amount mg | 5.0 | 4.5 | 3.9 | 4.9 | 3.6 | 0.6 | 6.3 | 8.5 |

TABLE 4

| | Example | | | | | | Comparative Example | |
|---|---|---|---|---|---|---|---|---|
| | 4-1 | 4-2 | 4-3 | 4-4 | 4-5 | 4-6 | 4-1 | 4-2 |
| First EPDM A | 50 | 60 | 65 | 70 | 60 | 32 | 100 | 65 |
| Second EPDM-(1) B | 50 | 40 | 35 | 30 | | | | 35 |
| Second EPDM-(2) B | | | | | 40 | 68 | | |
| PET Short Fibers | 12 | 12 | 12 | 12 | 12 | 12 | 12 | 12 |
| Nylon 66 Short Fibers | 18 | 18 | 18 | 18 | 18 | 18 | 18 | 18 |
| Aramid Short Fibers | | | | | | | | |
| Carbon Black | 60 | 60 | 60 | 60 | 60 | 60 | 60 | 60 |
| Process Oil | 5 | 5 | 5 | 5 | 5 | 5 | 5 | 5 |
| Zinc Oxide | 5 | 5 | 5 | 5 | 5 | 5 | 5 | 5 |
| Stearic Acid | 0.25 | 0.25 | 0.25 | 0.25 | 0.25 | 0.25 | 0.25 | 0.25 |
| Antioxidant | 2.5 | 2.5 | 2.5 | 2.5 | 2.5 | 2.5 | 2.5 | 2.5 |
| Organic Peroxide C | 2.8 | 2.8 | 2.8 | 2.8 | 2.8 | 2.8 | 2.8 | |
| Co-crosslinking Agent D | 1.5 | 1.5 | 1.5 | 1.5 | 1.5 | 1.5 | 1.5 | 1.5 |
| Sulfur | | | | | | | | 1.6 |
| Vulcanization Accelerator | | | | | | | | 4 |
| Average Ethylene | 60.5 | 58.8 | 57.95 | 57.1 | 56 | 58.8 | 52 | 57.95 |
| Content % by mass | | | | | | | | |
| Average ENB | 6.1 | 6.42 | 6.58 | 6.74 | 5.54 | 4.03 | 7.7 | 6.58 |
| Content % by mass | | | | | | | | |
| A/C | 17.9 | 21.4 | 23.2 | 25 | 21.4 | 11.4 | 35.7 | |
| B/C | 17.9 | 14.3 | 12.5 | 10.7 | 14.3 | 24.3 | — | |
| A/D | 33.3 | 40 | 43.3 | 46.7 | 40.0 | 21.3 | 66.7 | 43.3 |
| B/D | 33.3 | 26.7 | 23.3 | 20 | 26.7 | 45.3 | — | 23.3 |
| C/D | 1.87 | 1.87 | 1.87 | 1.87 | 1.87 | 1.87 | 1.87 | |
| Wear Amount mg | 3.4 | 3.2 | 2.1 | 3.2 | 2.7 | 1.7 | 4.2 | 5.8 |

(Wear Test and Results)

A wear test was conducted for each of Examples 1-1 to 1-6 and Comparative Examples 1-1 and 1-2, Examples 2-1 to 2-6 and Comparative Examples 2-1 and 2-2, Examples 3-1 to 3-6 and Comparative Examples 3-1 and 3-2, and Examples 4-1 to 4-6 and Comparative Examples 4-1 and 4-2.

Specifically, after measurement of the initial mass of the wear test sample, the wear test sample was set in a sample holder of a wear test machine. One end face of the wear test sample was brought into contact with a surface of a disc made of an FC200 material, and a load of 33.32 N was applied to the wear test sample toward the disc. In an atmosphere at a temperature of 23° C., the disc was rotated at a rotation speed of 48 rpm to cause the wear test sample to be slid on the surface of the disc at a speed of 0.15 m/s. After a lapse of seven hours, rotation of the disc was stopped. The wear test sample was removed from the sample holder, and the mass after the test was measured. A difference between the initial mass and the mass after the test of the wear test sample was calculated, and the difference was regarded as a wear amount.

The test results are shown in Tables 1 and 2. The results show that superior wear resistance is obtainable when the rubber component of the crosslinked rubber composition contains the first EPDM having the ethylene content of 52% by mass as the first polymer and the second EPDM-(1) having the ethylene content of 69% by mass as the second polymer or the second EPDM-(2) having the ethylene content of 62% by mass as the second polymer.

The embodiments have been described above as example techniques of the present disclosure, in which the attached drawings and the detailed description are provided. As such, elements illustrated in the attached drawings or the detailed description may include not only essential elements for solving the problem, but also non-essential elements for solving the problem in order to illustrate such techniques. Thus, the mere fact that those non-essential elements are shown in the attached drawings or the detailed description should not be interpreted as requiring that such elements be essential. Since the embodiments described above are intended to illustrate the techniques in the present disclosure, it is intended by the following claims to claim any and all modifications, substitutions, additions, and omissions that fall within the proper scope of the claims appropriately interpreted in accordance with the doctrine of equivalents and other applicable judicial doctrines.

What is claimed is:

1. A crosslinked rubber composition comprising:
a rubber component containing a first polymer that is an EPDM in which a diene component is ethylidene norbornene and in which an ethylene content is less than 60% by mass and a second polymer that is an EPDM in which a diene component is ethylidene norbornene and in which an ethylene content is 60% by mass or more; and
short fibers dispersed in the rubber component,
wherein
the rubber component is crosslinked by using organic peroxide as a crosslinking agent, and a content of the organic peroxide in a not-yet crosslinked rubber composition is 1 part by mass or more and 10 parts by mass or less relative to 100 parts by mass of the rubber component.

2. The crosslinked rubber composition of claim 1, wherein
an average ethylene content of the first and second polymers is 55% by mass or more and 65% by mass or less.

3. The crosslinked rubber composition of claim 1, wherein
an ENB content in the first polymer is 7% by mass or more.

4. The crosslinked rubber composition of claim 1, wherein
an ENB content in the second polymer is 2% by mass or more and 7% by mass or less.

5. The crosslinked rubber composition of claim 1, wherein
an average ENB content in the first and second polymers is 4% by mass or more and 7% by mass or less.

6. The crosslinked rubber composition of claim 1, wherein
the short fibers include polyester short fibers and/or nylon 66 short fibers.

7. The crosslinked rubber composition of claim 1, wherein
a ratio of a content of the first polymer to the content of the organic peroxide in the not-yet crosslinked rubber composition is 9.25 or more and 64 or less.

8. The crosslinked rubber composition of claim 1, wherein
a ratio of a content of the second polymer to the content of the organic peroxide in the not-yet crosslinked rubber composition is 5.5 or more and 46 or less.

9. The crosslinked rubber composition of claim 1, wherein
the rubber component is also crosslinked by using a co-crosslinking agent.

10. The crosslinked rubber composition of claim 9, wherein
a content of the co-crosslinking agent in the not-yet crosslinked rubber composition is 0.5 parts by mass or more and 40 parts by mass or less relative to 100 parts by mass of the rubber component.

11. The crosslinked rubber composition of claim 9, wherein
the content of the co-crosslinking agent in the not-yet crosslinked rubber composition is less than the content of the organic peroxide in the not-yet crosslinked rubber composition.

12. A crosslinked rubber composition comprising:
a rubber component containing a first polymer which is an ethylene-α-olefin elastomer having an ethylene content of less than 60% by mass and a second polymer which is an ethylene-α-olefin elastomer having an ethylene content of 60% by mass or more; and
short fibers dispersed in the rubber component,
wherein
both of the first and second polymers are EPDMs in which a diene component is ethylidene norbornene, and an average ENB content in the EPDMs is 4% by mass or more and 7% by mass or less, and
the rubber component is crosslinked by using organic peroxide as a crosslinking agent, and a content of the organic peroxide in a not-yet crosslinked rubber composition is 1 part by mass or more and 10 parts by mass or less relative to 100 parts by mass of the rubber component.

13. A friction transmission belt having a pulley contact surface made of the crosslinked rubber composition of claim 1 or 12.
